(19) United States
(12) Patent Application Publication
(10) Pub. No.: US 2017/0136357 A1
(43) Pub. Date: May 18, 2017

(54) RECORDING MEDIUM RECORDED WITH PROGRAM FOR BATTLE BOARD GAME CONTINUOUS TRANSFORMATION, AND ON-LINE SERVICE METHOD THEREOF

(71) Applicant: Cheol Ho MOON, Gyeonggi-do (KR)

(72) Inventor: Cheol Ho MOON, Gyeonggi-do (KR)

(21) Appl. No.: 15/319,994

(22) PCT Filed: Jun. 25, 2015
(86) PCT No.: PCT/KR2015/006518

§ 371 Date: Dec. 19, 2016

(30) Foreign Application Priority Data
Jun. 25, 2014 (KR) 10-2014-0077808

(51) Int. Cl. A63F 13/493; A63F 3/00

(52) U.S. Cl. CPC A63F 13/493; A63F 3/00643

(57) ABSTRACT

A recording medium stores a program for a battle board game using a continuous transformation. In the board game, game pieces having different shapes of different colors are put on a game map, and a winner is determined based on the number of the game pieces occupied on the game map. The recording medium or the program includes (a) forming conversion pieces by converting opponent game piece into a game piece identical to an attacking piece when three or more identical game pieces forms the attacking piece by being arranged continuously in at least one direction of a horizontal, a vertical, and an oblique direction and when the opponent game piece is placed in conversion points adjacent to the attacking piece; and (b) repeating to form the conversion piece when the attacking piece formed in a step of (a) until no conversion piece is formed.

### CROSS REFERENCE TO RELATED APPLICATIONS AND CLAIM OF PRIORITY

This application claims benefit under 35 U.S.C. 119(e), 120, 121, or 365(c), and is a National Stage entry from International Application No. PCT/KR2015/006518, filed Jun. 25, 2015, which claims priority to the benefit of Korean Patent Application No. 10-2014-0077808 filed in the Korean Intellectual Property Office on Jun. 25, 2014, the entire contents of which are incorporated herein by reference.

### BACKGROUND

1. Technical Field

Example embodiments relate to a recording medium storing (or including) a game program and an on-line service method. More particularly, embodiments of the present inventive concept relate to a recording medium storing (or including) a program for a battle board game using a continuous transformation (or consecutive conversion) and an on-line service board game service method thereof.

2. Description of the Related Art

A board game is a game played with a game board and a simple physical tool. A computer game played through the internet is called an on-line board game, and a game using a game board and a game piece is called an off-line board game. In a narrow sense, the board game includes a card game (e.g., a game using cards) consisted of a board and a paper, a game consisted of a pencil, a token, or a dice, and a game such as Chess, Omok, Go (or Baduk), and Reversi, etc. In a broad sense, the board game includes the on-line board game etc.

Looking at a typical board game, the Go game (or the Baduk game), which is the oldest and most popular board game, is the best strategy game on the ground with thousands of years of history. The Go game is a game in which users respectively having black stones and white stones alternatively put the stones on a check board (i.e., a board having 19 column lines and 19 row lines) (e.g., on the intersection of the lines) one by one. Here, one of the users competes to build houses (e.g., places surrounded by white stones or by black stones) more than houses of another user. The Go game is played only with the check board and the stones regardless of times and places. Through the Go game, the users use various strategies based on rules and highly mathematical and scientific thinking such that the Go game has a good effect on brains of the users and personality development of growing children as well as on leisure activities of adults and mental health.

However, the Go game requires a relatively long time to be finished (or be played) a match so that the users hardly play the Go game using spare times. In addition, the Go game is ignored by most teenagers and adults who play computer game and by growing children because it takes a lot of time to watch (or observe) the match and because the match proceeded with a conventional strategy.

A similar abstract strategy board game such as Caro or Reverosi has a simple rule, but does not have enough changes in game states (or game situations) based on the simple rule. The abstract strategy board game is not easy to expand to various contents. Therefore, the abstract strategy board game is not attractive enough to satisfy the user's taste.

On-line games using computers, smart phones, and etc are grown significantly based on recent changes and developments of information technology (referred to as IT) technique. However, the board games (e.g., traditional board games) become less popular due to its rigidity. Therefore, a game is required to easily use the IT technique and the wired/wireless on-line network and to be accessed by everyone.

### SUMMARY

Some example embodiments provide a recording medium and a service capable of improving accessibility of users, enlarging a range of the users, improving an immersion level for a game, improving a brain of the users, and improving use persistence with strong elements (or factors) of reversal.

According to example embodiments, a recording medium storing a program for a battle board game using a continuous transformation may be performed by a computing device, may put game pieces having different shapes of different colors on a game map among game maps with matrix-shape of M row and N column (where M and N are positive integer), and may determines a winner based on the number of the game pieces occupied on the game map. Here, the recording medium or the program may include (a) forming conversion pieces by converting opponent game piece into a game piece which is identical to an attacking piece when three or more identical game pieces including a game piece putted at an attacking time forms the attacking piece by being arranged continuously in at least one direction of a horizontal, a vertical, and an oblique direction and when the opponent game piece is placed in conversion points which are adjacent to the attacking piece; and (b) repeating to form the conversion piece when the attacking piece including at least one of the conversion pieces formed in a step of (a) until no conversion piece is formed.

In an example embodiment, M may be one of 4 through 19, and N may be one of 4 through 19.

In an example embodiment, the number of game pieces which are arranged continuously and which form the attacking piece may be 3, 4, or 5.

In an example embodiment, the conversion pieces may be points which are adjacent to ends of the attacking piece in an arrangement direction of the attacking piece and able to be placed with a game piece.

In an example embodiment, the conversion points may include closest points which are adjacent to ends of the attacking piece when the attacking piece is arranged in the horizontal direction or in the vertical direction, and side intersection points which are adjacent to two game pieces of the attacking piece by one space when the attacking piece is arranged in the oblique direction.

In an example embodiment, the conversion points may include closest points which are adjacent to ends of the attacking piece when the attacking piece is arranged in the horizontal direction, in the vertical direction, or in the oblique direction, and side intersection points which are adjacent to two game pieces of the attacking piece by one space when the attacking piece is arranged in the oblique direction.

In an example embodiment, the computing device may select at least one of the game pieces and may perform a battle with the at least one of the game pieces.

In an example embodiment, one who puts a game piece first may be determined as a loser when numbers of game pieces belong to each of users on the game map are equal to each other.

According to example embodiments, a board game service method may use a network system connected to user terminals and a game server and may proceed a battle by placing game pieces having different shapes or different colors on a game map of game maps with matrix-shape of M row and N column (where M and N are positive integer) alternately one by one. Here, the board game service method may include (a) registering users through the user terminals to the game server; (b) selecting at least one of a battle style, the game map, and the game pieces by the registered users through the user terminal; (c) forming conversion pieces by converting opponent game piece into a game piece which is identical to an attacking piece when three or more identical game pieces including a game piece putted at an attacking time forms the attacking piece by being arranged continuously in at least one direction of a horizontal, a vertical, and an oblique direction and when the opponent game piece is placed in conversion points which are adjacent to the attacking piece; (d) repeating to form the conversion piece when the attacking piece including at least one of the conversion pieces formed in a step of (c) until no conversion piece is formed; and (e) determining winner or loser by the dominance number of the game pieces occupying in the game map.

In an example embodiment, M may be one of 4 through 19, and N may be one of 4 through 19.

In an example embodiment, the number of game pieces which are arranged continuously and which form the attacking piece may be 3, 4, or 5.

In an example embodiment, the conversion pieces may be points which are adjacent to ends of the attacking piece in an arrangement direction of the attacking piece and able to be placed with a game piece.

In an example embodiment, the conversion points may include closest points which are adjacent to ends of the attacking piece when the attacking piece is arranged in the horizontal direction or in the vertical direction, and side intersection points which are adjacent to two game pieces of the attacking piece by one space when the attacking piece is arranged in the oblique direction.

In an example embodiment, the conversion points may include closest points which are adjacent to ends of the attacking piece when the attacking piece is arranged in the horizontal direction, in the vertical direction, or in the oblique direction, and side intersection points which are adjacent to two game pieces of the attacking piece by one space when the attacking piece is arranged in the oblique direction.

In an example embodiment, the battle style may be one of battle styles of 1 to 1 (1:1), 1 to 1 to 1 (1:1:1), 1 to 1 to 1 to 1 (1:1:1:1), 2 to 2 (2:2), and 3 to 3 (3:3).

In an example embodiment, four different game pieces may be putted on the game map alternately in the battle styles of 2 to 2 (2:2), and six different game pieces may be putted on the game map alternately in the battle styles of 3 to 3 (3:3).

In an example embodiment, the game server may select at least one of the game pieces and may perform a battle with the at least one of the game pieces.

In an example embodiment, the determining the winner or the loser (or the step (e)) may include determining one who puts a game piece first as a loser when numbers of game pieces belong to each of the users on the game map are equal to each other.

According to example embodiments, a computer program may be combined with the hardware may be stored in a recording medium storing a program for a battle board game using a continuous transformation

According to example embodiments, a computer program may be combined with the hardware and may be stored in a recording medium to perform the board game service method of a battle board game using a continuous transformation.

Therefore, the recording medium, the board game service method, the computer program may improve accessibility of users and may enlarge a range of the users by having a simple and easy-to-understand game rules.

In addition, the recording medium, the board game service method, the computer program may improve an immersion level for a battle board game with fun elements (or fun factors) by mixing (or having) characteristic of an abstract strategy board game and characteristic of a puzzle game.

Furthermore, the recording medium, the board game service method, the computer program may improve a brain of the user such as spatial perception abilities, computation abilities by using game rules of the puzzle game.

The recording medium, the board game service method may improve use persistence by having strong elements of reversal in which a battle state (or a game situation) achieves a sudden reversal by any one game piece.

In addition, the recording medium, the board game service method may increase fun elements, may expand to various contents, may have synergy effect with a social network, and may expand a range or the user by providing a various selection of battle styles, game maps, game pieces, items, etc.

### BRIEF DESCRIPTION OF THE DRAWINGS

Illustrative, non-limiting example embodiments will be more clearly understood from the following detailed description taken in conjunction with the accompanying drawings.

FIG. 1 is a flow diagram of a game process of a recording medium storing a program for a battle board game using continuous transformation according to example embodiments.

FIGS. 2A to 2B are a diagram illustrating an example of a game map used by the recording medium storing a program for a battle board game using continuous transformation according to example embodiments.

FIGS. 3A and 3B are diagrams illustrating an example of a horizontal attacking piece of a game rule used in the recording medium storing a program for a battle board game using continuous transformation according to example embodiments.

FIGS. 4A and 4B are diagrams illustrating an example of a vertical attacking piece of a game rule used in the recording medium storing a program for a battle board game using continuous transformation according to example embodiments.

FIGS. 5A and 5B are diagrams illustrating an example of an oblique attacking piece of a game rule used in the recording medium storing a program for a battle board game using continuous transformation according to example embodiments.

FIG. 6 is a diagram illustrating an example of a battle state (or a state of a battle) formed by the battle board game according to example embodiments.

FIGS. 7A to 7D are diagrams illustrating an example in which the battle state of the FIG. 6 proceeds and is greatly changed.

FIG. 8 is a flow diagram illustrating an on-line battle board game service method using continuous transformation according to other example embodiments.

FIG. 9 is a diagram illustrating a battle style of 1:1:1 used in the on-line battle board game service method using continuous transformation according to example embodiments.

FIG. 10 is a diagram illustrating a battle style of 1:1:1 used in the on-line battle board game service method using continuous transformation according to example embodiments.

### DESCRIPTION OF EMBODIMENTS

Hereinafter, the present inventive concept will be explained in detail with reference to the accompanying drawings.

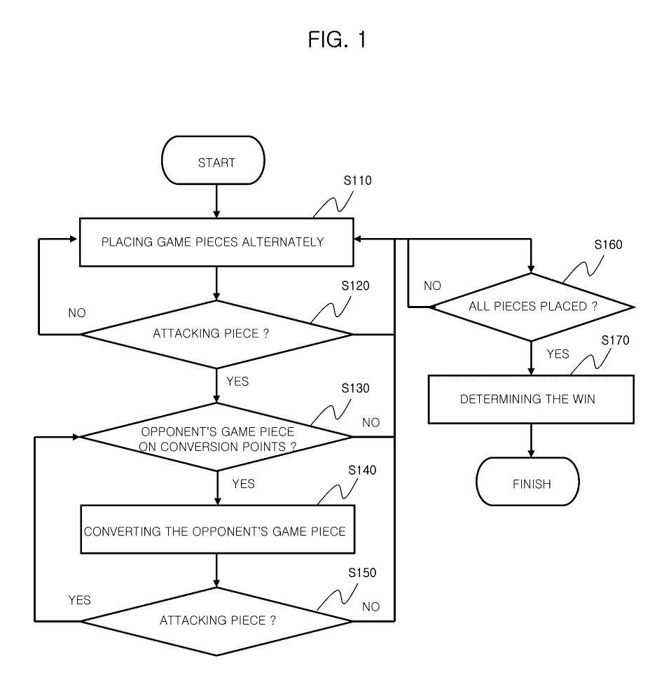

FIG. 1 is a flow diagram of a game process of a recording medium storing a program for a battle board game using continuous transformation according to example embodiments.

Referring to FIG. 1, the game process (or a game processor) may perform a program for a board game (or a board game program). The program (or a board game) may provide game maps with matrix-shape composed of M×N (i.e., M rows and N columns), may alternately place game pieces (or pieces, stones), which have different shapes and colors, one by one on a game map of the game maps, and may determine the winner based on comparative advantage of a number of the game pieces occupying the game map (i.e., may determine the winner who has more pieces occupying the game map). The game process may include (a) forming a conversion piece (or a converted piece, a transformed piece) by converting an opponent's game piece (e.g., a second game piece having a second shape or a second color) into a game piece which is the same as an attacking piece (or an attacking piece group, e.g., a first game piece having a first shape or a first color) when a game piece is placed at an attacking time (or at an attacking turn, or a turn of an attacker), when three or more identical game pieces including the placed game piece form the attacking piece by being arranged continuously (or consecutively) in at least one of a horizontal direction, a vertical direction, and a diagonal direction, and when the opponent's game piece is placed in a conversion point which is the closest to (or adjacent to) the attacking piece; and (b) forming a conversion piece when the attacking piece (or, a new attacking piece) including at least one of the converted piece which is converted in a step (a) (i.e., repeating a step (a) when a new attacking piece including the converted piece is formed) until a new conversion piece is not formed.

Here, a computing device performing the board game process or the recording medium including the board game process may be any device including an arithmetic processing device and a recording device for performing the board game process such as a personal computer (PC), a tablet PC, a mobile phone (or a smart phone), tablet PC, PDA, etc.

Like this, the example embodiments relate to the recording medium including the program for the abstract board game performing (or including) the game process. The game process, on the game map of the game maps with matrix-shape composed of M×N, may alternately place the game pieces having different shapes and colors one by one and may determine the winner based on comparative advantage of a number of the game pieces occupying the game map. The game process may form the attacking piece when a predetermined number of the game piece are arranged consecutively in at least one of the horizontal, the vertical and the diagonal directions, may convert the opponent's piece placed in a placing point which is the closest to the attacking piece, and may repeatedly and consecutively convert opponent's pieces when a new attacking piece is formed.

As applied terms in the example embodiments, the game map may be a game place shaped a board plate in which a board game is performed and may represent a map with matrix-shape composed of M×N. The game map may be a matrix map in which M row lines and N column lines are perpendicular to each other. Here, the board game is conducted by placing the game pieces on an intersection of the row lines and the column lines. Here, the game piece may represent players playing the board game in the program. A placing (or an action of placing) may be an action of putting (or placing) the game pieces at some place (e.g., a place in at which no game piece is placed) on the game map. A placing point (or a setting point) may be a position or the coordinate point corresponding to the action of the placing.

In example embodiments, the game map may be a map with matrix-shape composed of M×N. The map may be composed with a various number of row lines and column lines. The game pieces may be formed with various shapes and colors. For example, the game pieces may have a Go stone (or a stone of Baduk) or a specific character shape.

Referring to the FIG. 1, the board game process and game rules which are applied the example embodiments are as follows.

First of all, the game rule may be to place game pieces alternately on the game map one by one such that the game rule may determine the win or the loss (or a winner or a loser) based on the number of the game pieces occupying the game board when all points of the game board is occupied with the game pieces.

And, a first rule of the game may be to form the conversion piece by converting an opponent's game piece into the game piece which is identical to the attack piece when a game piece is placed at an attacking time, when three or more identical game pieces including the game piece form the attacking piece by being arranged consecutively in at least one of the horizontal direction, the vertical direction, and the diagonal direction, and when the opponent's game piece is placed in the conversion point which is the closest to the attacking piece. Here, the attacking piece (or an attacking piece group, an attackable zone) may be an array of a specific number of game pieces including the game piece placed at the attacking time and arranged consecutively in at least one of the horizontal direction, the vertical direction, and the diagonal direction. The conversion point may be a point of the game map at which the opponent's game piece is able to be changed by the attacking piece. The conversion piece may be a game piece which is converted.

The number of the game pieces forming the attacking piece may be desirable to set as 3, 4, or 5. The number of the game piece of the attacking piece may be set in various ways. However, the number of the game piece of the attacking piece may be 3, 4, or, 5 to speed up the board game and to induce various change.

A second rule of the game may be to continuously (or consecutively) perform a process to convert (or to change) the opposite's game piece placed at a closest point when a state in which the game piece is placed on the game map with respect to the game piece converted by the attacking piece in the first rule and when a new attacking piece is formed by including the converted game piece. The game process may proceed continuously until a new conversion piece is not formed by the converted game piece. If the new attack game piece is not formed, an attacking time (or an attacking turn) may goes over to the opponent.

The game may be proceeded using a way to place alternately game pieces one by one and the first and second rules to form the attacking piece and conversion piece. The game may be finished when there is no more placing point by placing game pieces on all points of the map. The game may determine the winner who has more pieces occupying the game map. The conversion piece formed by the attacking piece according to the first and second rules may be a process of the processor formed by placing a game piece of the users and may be automatically processed by the computing device such that the conversion piece may be displayed on the game map.

The game process according to example embodiments may be not simply a way to secure the game pieces on the game map, but the game process may be a way to change a number of the game piece by converting the opponent's game piece into a friend's game piece using a significant attacking pattern as the attacking piece and may be a way to greatly change the number of the game piece using a consecutive change to convert again the opponent's game piece by using a new attacking piece which is formed by the conversion piece.

Referring to FIG. 1, a game algorithm of the computing device performing the rules may allow the user to place the game piece one by one (S110), and may determine where the attacking piece is formed by some game pieces whenever one of the game pieces is placed on the game map for each attacking time and whenever locations of the game piece are changed in the game map (S120).

When the attacking piece is not formed according to the determination corresponding to the first rule (No), order of the game (or the attacking time or the attacking turn) may turn to the opponent. When the attacking piece is formed (Yes), the process may determine (or judge) whether there is the opponent's piece placed (or located) in the conversion point which is the closest to the attacking piece (S130). When there is the opponent game piece in the conversion point (Yes), the opponent's game piece may be automatically converted into the game piece identical to the attacking piece (S140). When an attacking piece is formed but when there is no opponent's game piece in the conversion point (No), the order of the game (or the attacking time or the attacking turn) may turn to the opponent.

And, the game algorithm may determine whether a new attacking piece is formed (S150). When the attacking piece is formed sequentially (Yes) (e.g., when there is the opponent piece at the conversion point, when the opponent's piece is converted into the game piece identical to attacking piece, and when the computing device judges whether a new attacking piece is formed by the converted piece), the game algorithm may judge (or determine) whether there is a new opponent's game piece in the new conversion point, and may performing the second rule automatically by the computing device to form again the converted piece when the new opponent's game piece is placed in the new conversion point (Yes). The second rule may continuously proceed until a new conversion piece is not formed by the conversion piece.

In addition, during the game process proceeds by placing the game pieces alternately (or playing alternately), the computing device may judge (or determine) whether all points of the game map is occupied with the game pieces (e.g., whether at least one of all points of the game map is empty or not occupied with the game pieces) (S160), may proceed by placing the game pieces when there is an empty point (No), and may determine/display the winner based on a number of the game pieces placed on the game map (and may finish a match or the game) (S170) when all points of the game map are occupied with the game piece) (Yes).

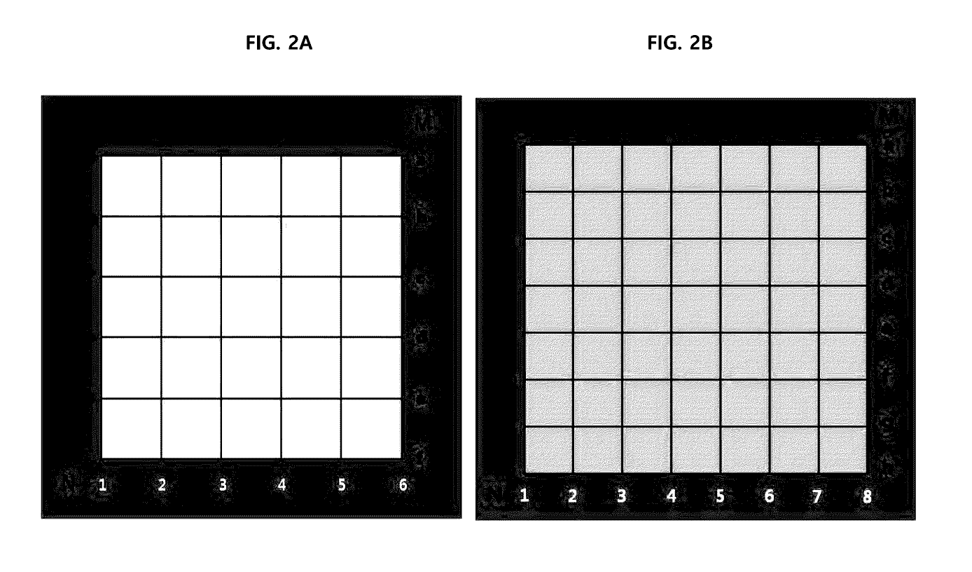

FIGS. 2A and 2B are diagrams illustrating an example of a game map used by the recording medium storing a program for a battle board game using continuous transformation according to example embodiments. The game map according to example embodiments may be selected among the game map with matrix-shape composed of M×N. As illustrated in FIGS. 2A and 2B, the game map may have even square matrix-shape composed of 6×6 or 8×8.

As described above, the game map may be one of various game maps of M×N. The game map may be even square matrix-shape preferably because a user places a game piece at a central point which is an important (or advantageous) according to the rules. In addition, when the game map is 6×6 or 8×8, the points in which the game pieces is placed may be formed with a number of 18 and 32 such that a time (or a playing time) of the game may be relatively decreased, and the game may have advantage of increasing game immersion and tension. On the other hand, when the game map of 10×10 or more may have many points such that the game may have advantage to represent various changes depending on the rules (or the game rules) and may require more deeper strategic thinking. That is, the game map of 10×10 may increase a fun factor (or an interesting factor) of the game.

The example embodiments may induce various fun of the game by changing game characteristics and tastes of the users.

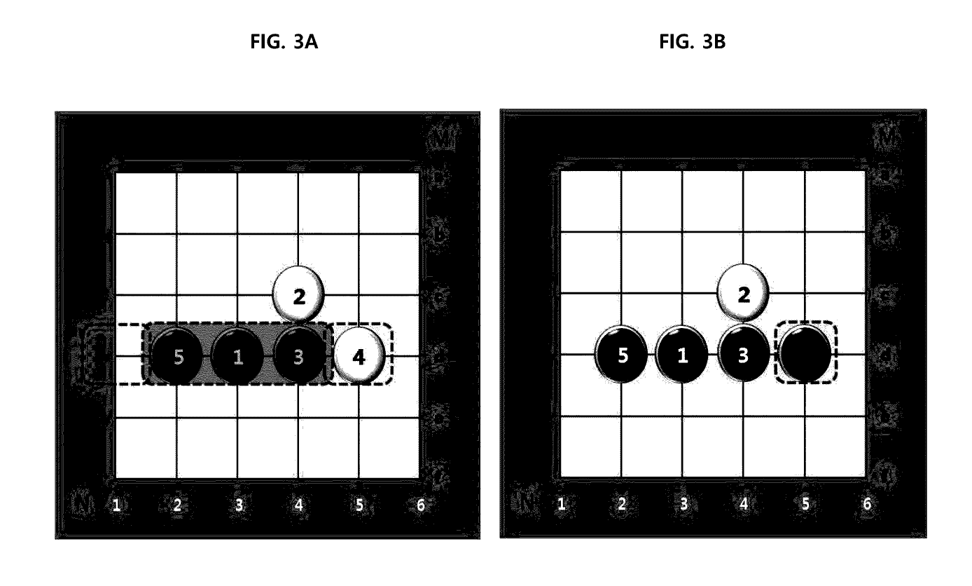

FIGS. 3A and 3B are diagrams illustrating an example of a horizontal attacking piece of a game rule used in the recording medium storing a program for a battle board game using continuous transformation according to example embodiments. The game rule applied to the example embodiments may include an attacking piece consecutively arranged in the horizontal direction with a certified number at an attacking time. FIGS. 3A and 3B show an example of the attacking piece in which three game pieces are consecutively arranged.

Referring to FIGS. 3A and 3B, after the game (or a match) is started and the placing alternately is proceeded, a white (or a game piece having a white color) may be placed in a fourth at a point 5d, and a black (or a game piece having a black color) may be placed in a fifth at a point 2d. Here, a first game piece, a third game piece, a fifth game piece (which has a block color) may be consecutively arranged such that the attacking piece may be formed. The computing device may judge (or determine) whether there is an opponent's piece in two conversion points which is adjacent to the attacking piece in the horizontal direction. For example, the computer device may determine that the fourth game piece of the white is in one of the conversion points as illustrated in FIG. 3A.

As illustrated in FIG. 3B, the conversion piece may be formed by converting the fourth game piece of the white into a game piece of the black (i.e., by converting a color of the fourth game piece to be black) which is identical to the attacking piece. A point d1 (e.g., a point at cross region of a row d and a column 1, i.e., d1) may be a conversion point in which a game piece is formed a conversion piece, but no change may occur because there is no an opponent's piece in the point d1.

In FIGS. 3A and 3B, three game pieces are formed the attacking piece by way of an example. Although the number of game pieces for forming the attacking piece is set to various numbers such as 4, 5 and so on, three game pieces may be formed easily (or may need relatively short time), and may cause a variety of changes according a probability to form the attacking piece is relatively high. Here, there may be factors that can double fun and game immersion. For this reason, the game process will be described with that the number of the attacking piece is set to as three hereinafter.

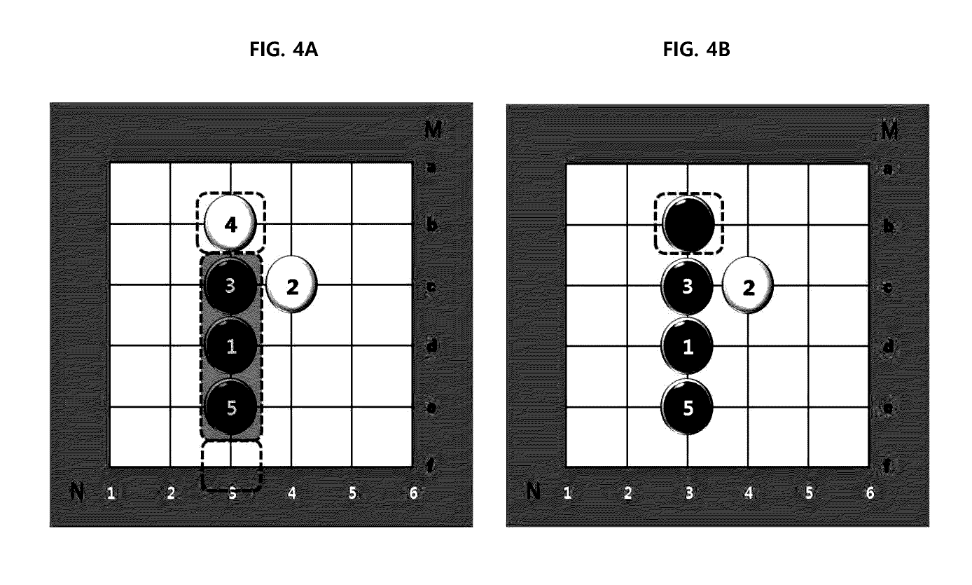

FIGS. 4A and 4B are diagrams illustrating an example of a vertical attacking piece of a game rule used in the recording medium storing a program for a battle board game using continuous transformation according to example embodiments. The game rule applied to the example embodiments may include that some game piece (e.g., 3 more game pieces) arranged continuously (or consecutively) in a vertical direction at an attacking time form an attacking piece. FIGS. 4A and 4B show an example of the attacking piece in which three game pieces are continuously arranged.

Referring to FIGS. 4A and 4B, after the game (or a match) is started and after the putting of the game piece alternately is proceeded, a fifth game piece of the black (or of a black color), a first game piece of the black, and a third game piece of the black may be continuously arranged in the vertical direction such that the attacking piece may be formed. Here, the computing device may judge (or determine) whether there is an opponent's piece in two conversion points (e.g., b3, f3) which is adjacent to the attacking piece in the vertical direction after the fifth game piece of the attacking piece is putted. The computer device may determine that the fourth game piece of the white is at a point b3 as illustrated in FIG. 4A.

As illustrated in FIG. 4B, the fourth game piece of the white may be converted into a game piece of the black (i.e., by converting a color of the fourth game piece to be black) which is identical to the attacking piece such that the conversion piece may be formed. A point f1 may be a conversion point in which a game piece is able to be formed a conversion piece, but no change may occur because there is no an opponent's piece in the point f3.

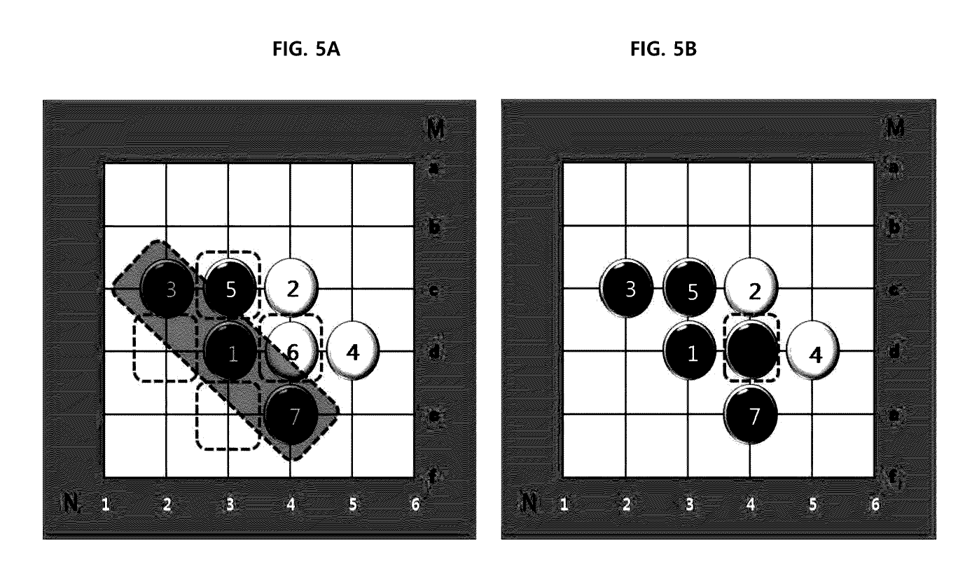

FIGS. 5A and 5B are diagrams illustrating an example of an oblique attacking piece of a game rule used in the recording medium storing a program for a battle board game using continuous transformation according to example embodiments. The game rule applied to the example embodiments may include that some game piece (e.g., 3 more game pieces) arranged continuously (or consecutively) in an oblique direction (or in a diagonal direction) at an attacking time form an attacking piece. FIGS. 5A and 5B show an example of the attacking piece in which three game pieces are continuously arranged.

Referring to FIGS. 5A and 5B, after the game (or a match) is started and after the putting of the game piece alternately is proceeded, a sixth game piece of the white (or of a white color) is putted, and then a seventh game piece of the black (or of a black color) is putted. Here, the seventh game piece, a first game piece, and a third game piece of the black may be continuously arranged in the oblique direction such that the attacking piece may be formed. Here, the computing device may judge (or determine) whether there is an opponent's piece in four conversion points (e.g., c3, e3, d2, and d4) which are respectively adjacent to two game piece selected from the attacking piece by one (or, one space) after the fifth game piece of the attacking piece is putted at a point c3. The computer device may determine that the sixth game piece of the white is at a point d4 as illustrated in FIG. 5A.

As illustrated in FIG. 5B, the sixth game piece of the white may be converted into a game piece of the black (i.e., by converting a color of the sixth game piece to be black) which is identical to the attacking piece such that the conversion piece may be formed.

Each of points c3, e3, and d2 may be a conversion point in which a game piece is able to be formed a conversion piece, but no change may occur because there is no an opponent's piece in the point f3.

In an example embodiment, unlike an example illustrated in FIGS. 5A and 5B, two points (e.g., b1 and f5) which are respectively adjacent to the oblique attacking piece in the oblique direction may become (or may be set as) the conversion points, similarly to the conversion points corresponding to the horizontal attacking piece and the vertical attacking piece. In an example embodiment, points which are respectively adjacent to two points selected from the attacking piece and closest points (i.e., points which are respectively adjacent to the oblique attacking piece in the oblique direction) by one (or, one space) may become the conversion points.

In a case of setting only the closest points at both ends of the oblique attacking piece as the conversion point, variation of the game state may be reduced. But in a case of setting the closest points and side intersection points (i.e., points which are respectively adjacent to two game piece selected form the oblique attacking piece) as the conversion point, the game state may vary dynamically and the game may be aggressive. An example illustrated in FIGS. 5A and 5B may be between above two cases and may have an effect of increasing the fun and game immersion as the variation and valance of game are appropriate.

Hereinafter, the game rules for the attacking piece applied to (or according to) example embodiments may be assumed as follows: conversion points corresponding to the horizontal and vertical attacking piece are the closest points which are respectively adjacent to ends of the attacking piece, and conversion points corresponding to the oblique attacking piece are side intersection points of the attacking piece.

As described above, the game rules according to example embodiments may include change by forming the attacking piece with three game pieces continuously arranged in the horizontal, vertical and oblique directions, and an attack method according to the game rules may be clear and easy. Therefore, players may conceive strategies for the game, and the rules may increase game immersion by inducing the variation of the game state.

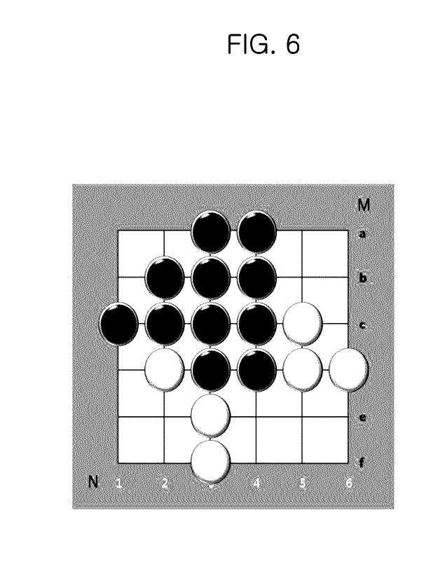

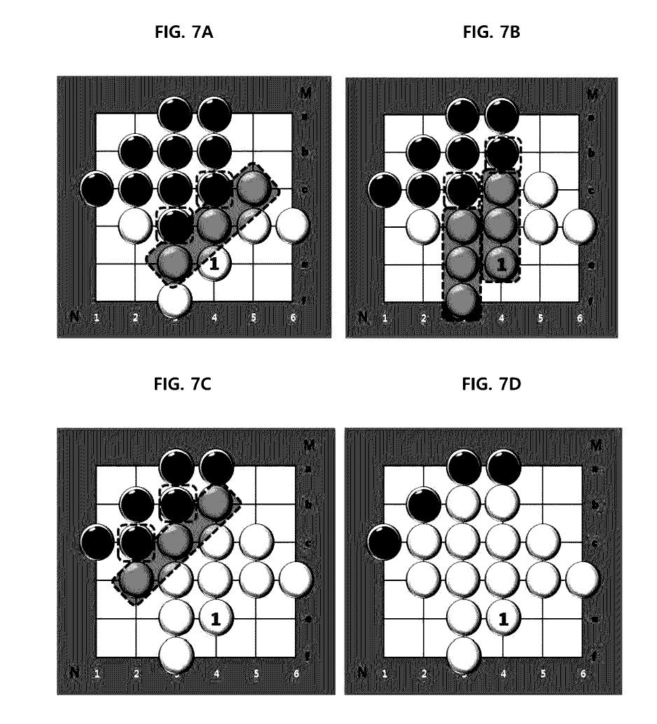

FIG. 6 is a diagram illustrating an example of a battle state (or a state of a battle) formed by the battle board game according to example embodiments. FIGS. 7A to 7D are diagrams illustrating an example in which the battle state of the FIG. 6 proceeds and is greatly changed.

Referring to FIG. 6, black pieces and white pieces are alternately putted and some of the black and white pieces may be converted based on the game rules foe the attacking piece and the conversion piece. As illustrated in FIG. 6, there may be 13 black pieces, and 6 white pieces on the game map. The number of the black pieces may be greater than the number of the white pieces. A game (or the game process) according to example embodiments may determine the winner who has more pieces occupying on the game map at the end of the game. Similarly, a current battle state may be determined based on the number of the game pieces. FIG. 6 shows the dominance of the black pieces and shows that a new attacking piece can be formed by a point (or a setting point, a putting point, a placing point) e4 in a turn to place the white pieces (or at an attacking time of the white).

As described above, although the game pieces (e.g., the black pieces and the white piece) are alternately putted on the game board, changes of the battle state represented by the number of the game pieces may occur (or change) in variety of ways according to the game rules for the attacking piece and the conversion piece.

FIGS. 7A to 7D are diagrams illustrating an example in which the battle state of FIG. 6 is changed by one white game piece. FIG. 7D shows the big change in the dominance pieces from the black to the white comparing with the battle state illustrated in FIG. 6.

Referring to FIG. 7A, if a white piece is placed in (or putted at) a first point 1 with respect to the battle state of FIG. 6, the attacking piece may be formed in the oblique direction through points d5, e4, and f3. A black piece is converted into a white piece which is identical to the attacking piece because the black piece is placed in a point d4 which is one of four conversion points d4, e3, e5, and f4 located in (or which are) side intersection points of the attacking piece. By the conversion (i.e., by a conversion piece), a new attacking piece may be continuously formed on points c5, d4, and e3. And, a new conversion point may be formed on points c4 and d3 by the new attacking piece.

Referring to FIG. 7B, because black pieces, which are an opponent's game pieces, are placed in the new conversion points (c4 and d3), the black pieces located in points c4 and d3 is converted into white pieces. by the conversion, two vertical attacking pieces (or new vertical attacking pieces) respectively including the white pieces on the points c4 and d3.

The vertical attacking pieces may include a first attacking piece placed on points d3, e3, and f3 and a second attacking piece placed on points c4, d4, and e4. black pieces may be converted into white pieces because the black pieces are placed in the conversion point c3 formed by the first attacking piece consisted of the points d3, e3, and f3 and in the conversion point b4 formed by the second attacking piece consisted of the points c4, d4, and e4.

Referring to FIG. 7C, the black pieces placed in the conversion point c3 and b4 formed by the two vertical attacking pieces illustrated in FIG. 7B may be converted into the white pieces. By the conversion of the black pieces, a new oblique attacking piece consisted of points b4, c3, and d2 may be continuously formed. After this, new conversion points b3 and c2 may be formed by the new oblique attacking piece consisted of points b4, c3, and d2, and black pieces placed in the conversion points b3 and c2 may be converted into white pieces which are identical to the attacking pieces.

Referring to FIG. 7D, the black pieces placed in the conversion points b3 and c2 are converted into the white pieces as illustrated in FIG. 7C, and a continuous transformation (or a consecutive conversion) may occurs until a new conversion piece is not formed by the attacking pieces which is formed by the white pieces converted in the conversion points b3 and c2. As illustrated in FIG. 7D, new oblique attacking piece consisted of points b3, c4, and d5 may be formed by the conversion piece at the conversion point b3, and new oblique attacking piece consisted of points c2, d3, and e4 may be formed by the conversion piece at the conversion point c2. However, a new conversion piece may not be formed no more because an opponent's game piece (i.e., a black piece) is not placed in the new conversion point formed by the attacking pieces. Here, a chance to place a piece may go over to an opposite player.

As described above, the big change in the dominance of game pieces may occur by placing only a game piece. Therefore, an inversion factors may increase game immersion and may change the dominance of the game pieces, willingness to continue games may be increased.

A board game process applied to (or according to) example embodiments may use the game map with matrix-shape composed of M×N and may form (or set, determine) the game pieces with various shapes and colors. For example, the game map may be implemented in a form of a spider web, and the game pieces may be the spider characters.

The board game according to example embodiments may increase the fun of the game by setting the game map and the game pieces having various shapes and colors characters. In addition, the board game may increase game immersion and willingness to continue game by adding various effects such as a background, a sound, etc. Furthermore, the board game may expand to the various service contents. That is, the board game may have advantages to make a game story by using the game character and to have deeper and more fun elements by adding various contents.

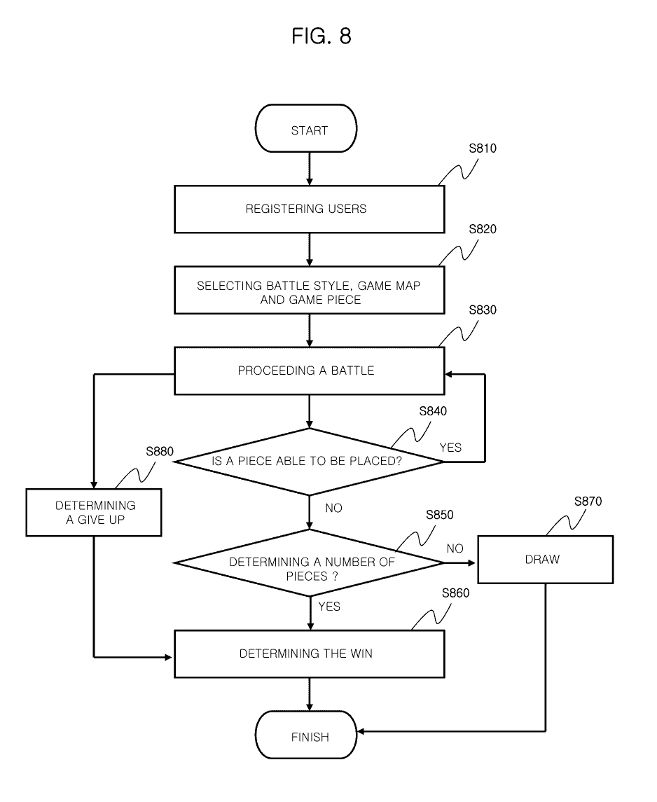

FIG. 8 is a flow diagram illustrating an on-line battle board game service method (or a method of servicing or providing an on-line board game) using continuous transformation according to other example embodiments.

Referring to FIG. 8, the method of FIG. 8 may use a network system including a user terminal and a game server which are connected through an internet. The method of FIG. 8 may be performing a match (or a battle) by placing game pieces, which have various shapes and colors, alternatively one by one on a game map of game maps with a matrix-shape composed of M×N. The method of FIG. 8 may include (a) registering (or a step to register) a user through the user terminal to the game server; (b) selecting (or a step to select) at least one among a battle style, the game map. and the game pieces by the user registered through the user terminal; (c) forming (or a step to form) a conversion piece by converting an opponent game piece into a game piece which is identical to an attacking piece when three or more game piece including a game piece placed at a current attacking time (or at a placing time) forms (or consist of) the attacking piece by being continuously arranged in at least one direction of horizontal, vertical, and oblique (or diagonal) directions, and when the opponent's game piece is placed in the conversion point which is the closest (or adjacent) to the attacking piece; (d) forming (or a step to form) the conversion piece until a new conversion piece is not formed when new attacking piece including at least one of the conversion piece formed in the step (c); and (e) finishing (or a step to finish, a step to end) a game and determining (or a step to determine) the win or the loss by dominance number of the game pieces occupying in the game map.

Here, the user terminal may be any device that can perform a process of the board game (or a board game process) such as a PC, a tablet PC, a PDA, a smart phone, a terminal for a game and so on equipped with an arithmetic processing device and a recording device. The game server may be any device that can perform a process of the board game (or a board game process) such as a PC, a tablet PC, a PDA, a smart phone, a terminal for a game and so on equipped with an arithmetic processing device and a recording device.

The network system may be a wired or wireless network system, for example, the network system may be a communication network system between the user terminal and a web server with a wire or between the user terminal and a mobile server with a wireless.

That is, many users may access the game server through wired or wireless internet communication network with the user terminal and may proceeds the process of the game battle (or a game match) by communicating various data with the game server through an executive file of a program of the board game installed in the user terminal and by executing the program of the board game. The method of FIG. 8 may provide on-line web game services or mobile game services using smart phones. The method of FIG. 8 may be applied to on-line game services using various network systems. A battle process may be the same as or substantially the same as the game battle process described with reference to FIGS. 1 through 8. Therefore, duplicated description will be omitted, and the game rules and terms used hereinbefore may be used in the same way.

Referring to FIG. 8, the on-line battle board game service according to example embodiments may register the user in game server through the user terminal in the step (a) (S810). The user may register user information through a user ID and password in the user terminal such as a smart phone, a PC, or etc. The ID (or password) may be the same as a user authentication number capable of receiving an access authorization to the game server.

Many users may store user information in the game server through the user registration. The game server may display various game information such as a game history of the user, a game result, and a score based on the user information stored in the database through the user terminal and may provide the user with various information necessary for (or used in) the game.

In the step (b), when the registered user accesses the game server to perform the game through the user terminal, the user may select one of options such as the battle style, the game map, and game pieces displayed on the user terminal (S820). The selection may provide the user with various types of game using simple game rules described above, and the user may play various types of the games to their taste.

Here, it is possible to select one of the ways 1:1, 1:1:1, 1:1:1:1, 2:2 and 3:3 in the battle style. In the battle style, players may place game pieces alternately using different game pieces. In the battle styles of 2:2 and 3:3 which is similar to a battle style of 1:1 by team, the game pieces on the same side (or the same team) may be not changed by the attacking piece, and the attacking piece may not be formed by mixing game pieces on the same side (i.e., the attacking piece may be restricted).

Example embodiments may form the battle style (or a game method) in various combinations because many users access and play the game. Therefore, example embodiments may provide the user with a variety of content. The game map and the game pieces may be as described above.

The steps (c) and (d) may be steps to proceed a battle process (S830) and may be the same as or substantially the same as the process described with reference to FIG. 1. Therefore, duplicated description will be omitted.

In the step (e), the game server may determine (or judge) whether the game piece is able to be placed on the game map during the game (S840). If it is possible to place the game piece (Yes), the server may proceed to place the game piece alternately. If it is not possible to place the game piece (No), the server may determine the winner who has more pieces occupying on the game map (S850). Here, if the number dominance of the game pieces occupying on the game map is determined on either side (Yes), the winner may be determined accurately (S860). If not (No), the game server may finish with a draw or may determine the win or the loss by applying a rule that a just before placed piece is defeated (S870). Because a player putting a game piece first is relatively advantageous.

In an example embodiment, if either player exits the game server or give up the game during the battle, and if the game cannot be played anymore, the process decides the give up game piece as a loser and the game ends (S880).

If a player is offensive to the opposite player or breaks the game, the game player may be replaced with the game server constituted by a computing devise, and the game may proceed.

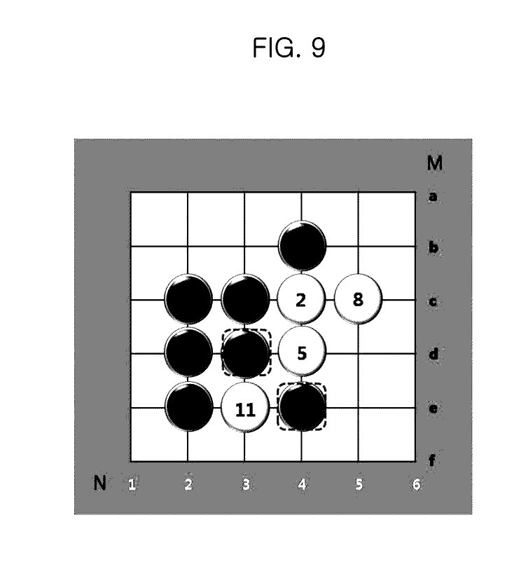

FIG. 9 is a diagram illustrating a battle style of 1:1:1 used in the on-line battle board game service method using continuous transformation according to example embodiments. FIG. 9 shows a battle of 1:1:1 in which three game players using the three kinds of game pieces: yellow color, purple color and red color. The battle illustrated in

FIG. 9 may be applied the rule that game pieces of each player independently to each other. An attacking piece and conversion piece may affect not only one specific game piece (or one type game piece) but all opponent's game pieces.

Referring to FIG. 9, an oblique attacking piece consisted of 11th, 5th, and 8th game pieces may be formed when the 11th game with a yellow color is placed. Points c4, e4, d3, and d5 may become conversion points by the attacking piece. A game piece with a purple color in the point d3 and a game piece with a red color in the point e4 of the four conversion points may be formed conversion piece by being converted into game pieces with yellow color.

Unlike the battle style of 1:1 performed by two players, the battle style of the 1:1:1 may have a unique fun element to make a strategy to judge both sides of each other piece instead of a strategy to attack or defend against any one piece. For example, when one game piece attacks another game piece, the battle state of the game may be changed by a transformation (or a conversion) of another game piece, and the other game piece may be relatively weakened by the dominance of either game piece. Here, the other game piece may defense the game piece instead of another game piece when another game piece is likely to receive a big attack.

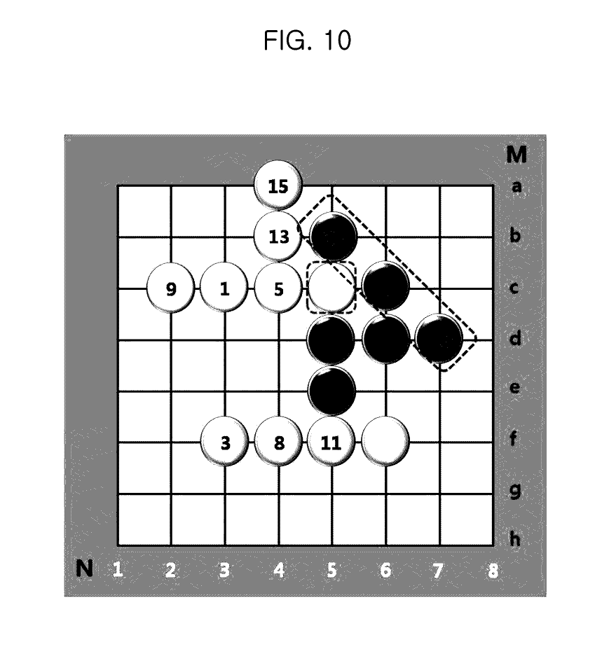

FIG. 10 is a diagram illustrating a battle style of 1:1:1 used in the on-line battle board game service method using continuous transformation according to example embodiments. As illustrated in FIG. 10, the battle style may be a team play way in which the yellow color and green color are on one side, and the red color and the purple color are on the other side. Game pieces on the same side may not be affected by an attacking piece or a conversion piece, but may be affected only by opponent's game pieces (or by game pieces of the other side).

Referring to FIG. 10, it is possible to form an oblique attacking piece consisted of the fourth and twelfth game pieces with the purple color when a game piece with the purple color is placed in a point a4. Here, game pieces with the yellow color in conversion points b4 and c5 may form the conversion pieces by being converted into game pieces with purple color. Therefore, a game piece with the green color which is the same side with the yellow may defense by placing a 15th game piece with the green color at an attacking time of the green.

As described above, the battle style applied to example embodiments may be suitable for the on-line game service using network and may expand various contents in that players should not only build a strategy for attacking and defending own game pieces, but a strategy for attacking or defending the same side.

As illustrated in FIG. 10, an oblique attacking piece consisted of 12th, 4th, and 16th game pieces by placing the 16th game piece such that conversion points may be formed at points c5 and d6. Here, only the game pieces of the yellow color of the opponent may be converted into game pieces of the purple color. Each of the game pieces may perform a match process independently, and the attacking piece and the conversion piece (or the conversion points) may not affect the same side (or the same team).

Therefore, the match style (or a team playing method) of 2:2 may meet needs of game users on social network such as SNS who want to play by connecting the game user connected to each other, and may create a more various game environment with various content expansions such that more game users may be secured.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

1. A recording medium storing a program for a battle board game using a continuous transformation which is performed by a computing device, which puts game pieces having different shapes of different colors on a game map among game maps with matrix-shape of M row and N column (where M and N are positive) integer, and which determines a winner based on a number of the game pieces occupied on the game map,
wherein the program comprises:
(a) forming conversion pieces by converting opponent game piece into a game piece which is identical to an attacking piece when three or more identical game pieces including a game piece putted at an attacking time forms the attacking piece by being arranged continuously in at least one direction of a horizontal, a vertical, and an oblique direction and when the opponent game piece is placed in conversion points which are adjacent to the attacking piece; and
(b) repeating to form the conversion piece when the attacking piece including at least one of the conversion pieces formed in a step of (a) until no conversion piece is formed.

2. The recording medium of claim 1, wherein M is one of 4 through 19, and N is one of 4 through 19.

3. The recording medium of claim 1, wherein a number of game pieces which are arranged continuously and which form the attacking piece is 3, 4, or 5.

4. The recording medium of claim 3, wherein the conversion pieces are points which are adjacent to ends of the attacking piece in an arrangement direction of the attacking piece and able to be placed with a game piece.

5. The recording medium of claim 1, wherein the conversion points include:
closest points which are adjacent to ends of the attacking piece when the attacking piece is arranged in the horizontal direction or in the vertical direction, and
side intersection points which are adjacent to two game pieces of the attacking piece by one space when the attacking piece is arranged in the oblique direction.

6. The recording medium of claim 5, wherein the conversion points include:
closest points which are adjacent to ends of the attacking piece when the attacking piece is arranged in the horizontal direction, in the vertical direction, or in the oblique direction, and
side intersection points which are adjacent to two game pieces of the attacking piece by one space when the attacking piece is arranged in the oblique direction.

7. The recording medium of claim 5, wherein the computing device selects at least one of the game pieces and performs a battle with the at least one of the game pieces.

8. The recording medium of claim 5, wherein one who puts a game piece first is determined as a loser when numbers of game pieces belong to each of users on the game map are equal to each other.

9. A board game service method using a network system connected to user terminals and a game server and proceeding a battle by placing game pieces having different shapes or different colors on a game map of game maps with matrix-shape of M row and N column (where M and N are positive integer) alternately one by one, the board game service method comprising:
(a) registering users through the user terminals to the game server;
(b) selecting at least one of a battle style, the game map, and the game pieces by the registered users through the user terminal;
(c) forming conversion pieces by converting opponent game piece into a game piece which is identical to an attacking piece when three or more identical game pieces including a game piece putted at an attacking time forms the attacking piece by being arranged continuously in at least one direction of a horizontal, a vertical, and an oblique direction and when the opponent game piece is placed in conversion points which are adjacent to the attacking piece;
(d) repeating to form the conversion piece when the attacking piece including at least one of the conversion pieces formed in a step of (c) until no conversion piece is formed; and
(e) determining winner or loser by the dominance number of the game pieces occupying in the game map.

10. The board game service method of claim 9, wherein M is one of 4 through 19, and N is one of 4 through 19.

11. board game service method of claim 9, wherein a number of game pieces which are arranged continuously and which form the attacking piece is 3, 4, or 5.

12. The board game service method of claim 11, wherein the conversion pieces are points which are adjacent to ends of the attacking piece in an arrangement direction of the attacking piece and able to be placed with a game piece.

13. The board game service method of claim 9, wherein the conversion points include:
closest points which are adjacent to ends of the attacking piece when the attacking piece is arranged in the horizontal direction or in the vertical direction, and
side intersection points which are adjacent to two game pieces of the attacking piece by one space when the attacking piece is arranged in the oblique direction.

14. The board game service method of claim 13, wherein the conversion points include:
closest points which are adjacent to ends of the attacking piece when the attacking piece is arranged in the horizontal direction, in the vertical direction, or in the oblique direction, and
side intersection points which are adjacent to two game pieces of the attacking piece by one space when the attacking piece is arranged in the oblique direction.

15. The board game service method of claim 13, wherein the battle style is one of battle styles of 1 to 1 (1:1), 1 to 1 to 1 (1:1:1), 1 to 1 to 1 to 1 (1:1:1:1), 2 to 2 (2:2), and 3 to 3 (3:3).

16. The board game service method of claim 13, wherein four different game pieces are putted on the game map alternately in the battle styles of 2 to 2 (2:2), and
wherein six different game pieces are putted on the game map alternately in the battle styles of 3 to 3 (3:3).

17. The recording medium of claim 13, wherein the game server selects at least one of the game pieces and performs a battle with the at least one of the game pieces.

18. The recording medium of claim 13, wherein the (e) determining the winner or the loser includes:
determining one who puts a game piece first as a loser when numbers of game pieces belong to each of the users on the game map are equal to each other.

19. A computer program combined with the hardware and stored in the recording medium of claim 1.

20. A computer program combined with the hardware and stored in a recording medium to perform the board game service method of claim 9.
